(19) United States
(12) Patent Application Publication
(10) Pub. No.: US 2011/0151389 A1
(43) Pub. Date: Jun. 23, 2011

(54) AIR-GAS PREMIXING DEVICE IN A LOW-NOX GAS BURNER

(75) Inventors: Ruben CATTANEO, Brescia (IT); Flavio COMENCINI, Legnago (IT)

(73) Assignee: RIELLO S.P.A., Legnago (IT)

(21) Appl. No.: 12/974,309

(22) Filed: Dec. 21, 2010

(30) Foreign Application Priority Data
Dec. 22, 2009 (IT) BO2009A 000818

(51) Int. Cl. F23D 14/62; B01F 3/02

(52) U.S. Cl. 431/354; 48/187

(57) ABSTRACT

An air-gas premixing device to be inserted into a low-NOx gas burner.

The device comprises a ring nut adapted to rotate about a symmetry axis passing through its geometric center.

The rotation of the ring nut causes:
the rotation of a shutter for closing/opening an air-passage section for a fraction of the air from a ventilation group; and
the rotation of a premixing pipe provided with an eyelet for the passage of a combustible gas; so that the air and the combustible gas are mixed in said premixing pipe to obtain a decrease of NOx emissions.

The present invention relates to a low-NOx air-gas premixing device.

In particular, the present invention is advantageously, but not exclusively, applied in a gas burner, to which explicit reference will be made in the following description without therefore loosing in generality.

### BACKGROUND OF THE INVENTION

As known, one of the most important problems which are found in the management of a gas burner is related to the control of harmful NOx emissions into the atmosphere.

### SUMMARY OF THE INVENTION

The object of the air-gas premixing device of the present invention is to obtain a considerable decrease of NOx emissions, the efficiency produced by the combustion system being equal, by means of fine adjustment, of a purely mechanical nature, of the comburent/combustible premixing.

It is thus the main object of the present invention to provide an air-gas premixing device, which allows a considerable decrease of NOx released into the environment, while maintaining the high efficiency of the burner to which the device is applied. It is a further object of the present invention to design a gas burner equipped with the aforesaid air-gas premixing device.

According to the present invention, an air-gas premixing device and a corresponding gas burner are thus provided as claimed in the attached claims.

### BRIEF DESCRIPTION OF THE DRAWINGS

For a better understanding of the present invention, a preferred embodiment will now be described by way of merely non-limiting example, and with reference to the accompanying drawings, in which:

FIG. 1 shows a longitudinal section of a gas burner in which an air-gas premixing device according to the present invention is integrated;

FIG. 2 shows an axonometric view of an air-gas premixing device assembly according to the present invention;

FIG. 3 shows some elements included in the device in FIG. 2;

FIG. 4 shows a single element also included in the device in FIG. 2;

FIG. 5 shows different opening positions of a shutter belonging to the device in FIG. 2;

FIG. 6 shows a curve, where the abscissa shows the rotation angle of the mixing air shutter element, while the ordinate shows the actual values of the air-passage area;

FIG. 7 shows the elements in FIG. 3 seen from another point of view;

FIG. 8 shows a curve, where the abscissa shows the rotation angle of the mixing air shutter element, while the ordinate shows the actual values of the passage area of the gas which is mixed in the device shown in FIG. 2;

FIG. 9 shows a curve which illustrates the production of NOx according to the so-called “Equivalence Ratio” Φ in a burner onto which a device of the type shown in FIG. 2 is not fitted; and

FIG. 10 shows a curve which illustrates the production of NOx according to the so-called “Equivalent Ratio” Φ in a burner in which a device of the type shown in FIG. 2 is integrated; FIG. 10 also contains a comparison with the curve in FIG. 9.

### DETAILED DESCRIPTION OF THE INVENTION

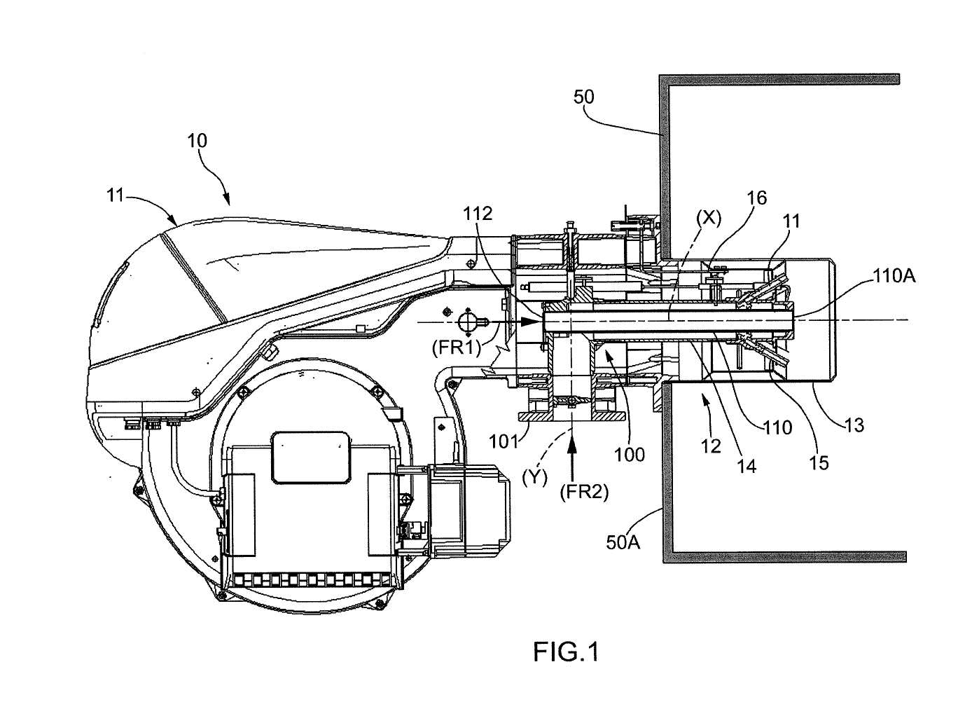

In FIG. 1, numeral 10 indicates as a whole a gas burner of the traditional type to which an air-gas premixing device 100 according to the present invention has been applied.

Gas burner 10 is fixed to a wall 50A of a boiler 50.

Gas burner 10 further comprises a ventilation group 11 to which a combustion head 12 is attached.

The part of combustion head 12 facing towards the inside of boiler 50 is contained in an outer pipe 13.

The comburent air is sent by the ventilation group 11 to the combustion head 12 according to an arrow (FR1), parallel to a longitudinal horizontal axis (X), while the combustible gas enters into the combustion head 12 through a sleeve 101, flowing according to an arrow (FR2) parallel to a vertical axis (Y). Axes (X) and (Y) are perpendicular to each other.

As shown again in FIG. 1, all the combustible gas enters into a conduit 14 which is coaxial to the outer pipe 13 according to axis (X), and is split into a first portion which flows into device 100, according to modes which will be seen in greater detail below, and in a second portion which flows in conduit 14 towards a free end of the combustion head 12 through a series of nozzles 15 arranged in a “fan” pattern with respect to axis (X).

When the gas exits from the nozzles 15, it is mixed with the primary air conveyed into the outer pipe 13, and the air-gas mix which is locally produced is ignited by an electrode 16.

In the meantime, the combustion is ignited in the air-gas mix which is formed within device 100 when such a mix exits from an opening 110A at the free end of a premixing pipe 110 belonging, as will be seen in greater detail below, to the device 100 provided according to the teachings of the present invention.

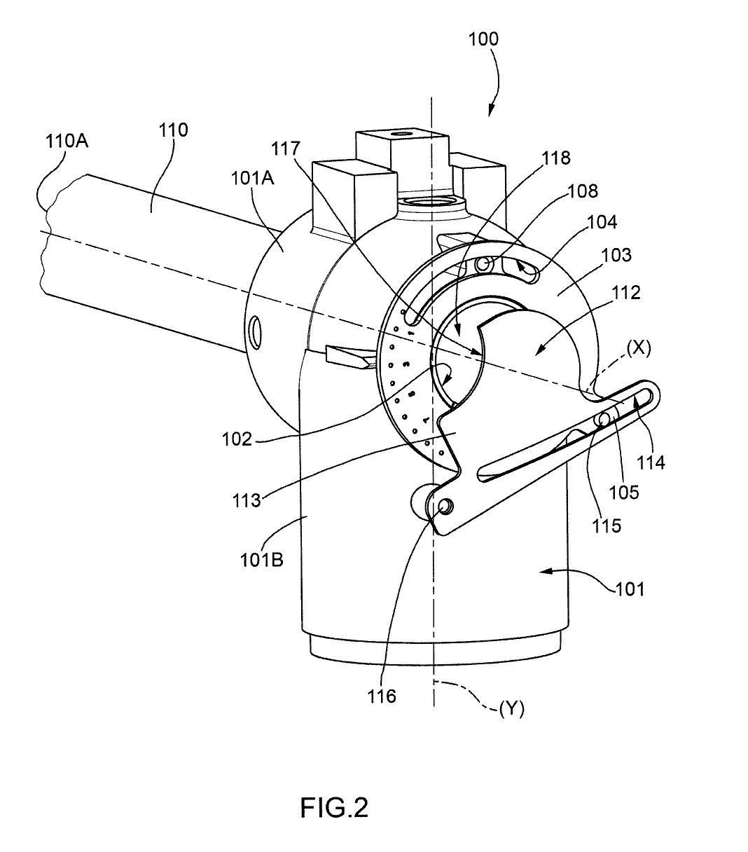

In FIG. 2, numeral 100 indicates as a whole the air-gas premixing device according to the present invention.

Device 100 comprises a substantially “L”-shaped sleeve 101 which thus includes a horizontal portion 101A, of longitudinal axis (X), elbow-joined to a vertical portion 101B, of longitudinal axis (Y).

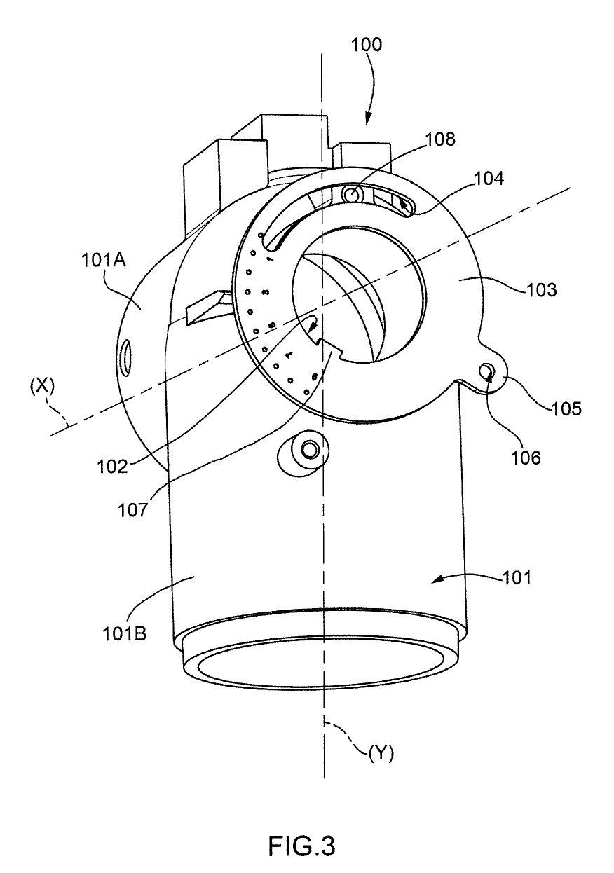

Sleeve 101, in turn, has a circular through hole 102 at the elbow. The edge of the through hole 102 is surrounded by a circular crown-shaped ring nut 103 (FIGS. 2, 3). Such a ring nut 103 (FIGS. 2, 3) has an arc-of-circumference-shaped slot 104, an ear 105 provided with a corresponding threaded hole 106 and a tab 107.

As shown in FIG. 3, while ear 105 protrudes outwards from the ring nut 103, tab 107 extends into the circular through hole 102.

When the ring nut 103 is mounted to sleeve 101, the slot 104 is engaged by a threaded pin 108 screwed into a corresponding threaded seat obtained on the surface of sleeve 101 (FIGS. 1, 2). Manually loosening the threaded pin 108 allows the ring nut 103 to be manually rotated about its center.

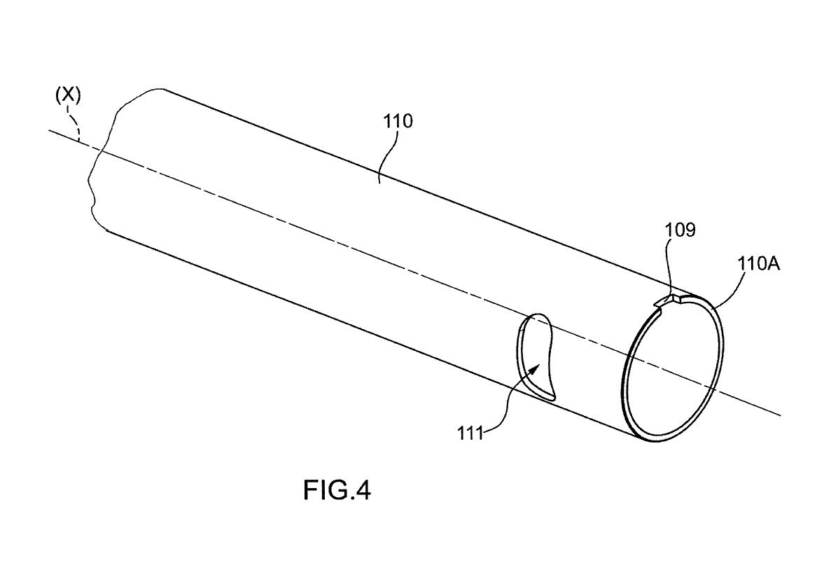

In use, tab 107 is engaged with a recess 109 provided at the end 110A of the premixing pipe 110 (FIG. 4), which when inserted into the through hole 102, also has the same longitudinal axis (X) as the horizontal portion 101A of sleeve 101.

Furthermore, as shown in FIG. 4, there is an eyelet 111 on the cylindrical surface of the premixing pipe 110, through which a portion of the combustible gas conveyed into the vertical portion 101B of sleeve 101 passes (see below).

Device 100 further comprises a partialization shutter 112 as wide as the opening of through hole 102.

As shown in FIG. 2, shutter 112 comprises, in turn, a shaped plate 113 provided with a curvilinear arc-shaped groove 114, in which a screw 115 screwed into the threaded hole 106 obtained in ear 105 (FIG. 3) may slide. Therefore, screw 115 allows shutter 112 to be fastened to the ear 105 of the ring nut 103. Moreover, shutter 112 is fixed to the vertical portion 101B of sleeve 101 by means of a screw 116 (FIG. 2).

As shown in FIG. 2, plate 113 is shaped so as to include an appropriately shaped recess 117.

By loosening the two screws 115, 116, shutter 112 may be rotated, either manually or by means of a servomechanism (not shown), by means of the rotation of ring nut 103, so as to increase or decrease, by means of the shaped plate 113, an air-passage section 118 for a fraction of the air from the ventilation group 11 which is arranged upstream of device 100 (FIG. 1).

FIG. 5 shows a sequence of possible configurations of the partialization shutter 112 for angle values in the range from 0° to 40° (maximum mechanical limit allowed by the ring nut 103) and in 5° increments. The geometric center of rotation of shutter 112 is given by the screw 116.

FIG. 5 also shows the mentioned air-passage section 118 of the circular section of the premixing pipe 110 which does not remain covered by the shutter 112, and which thus allows a fraction of the air from the ventilation group 11 to pass.

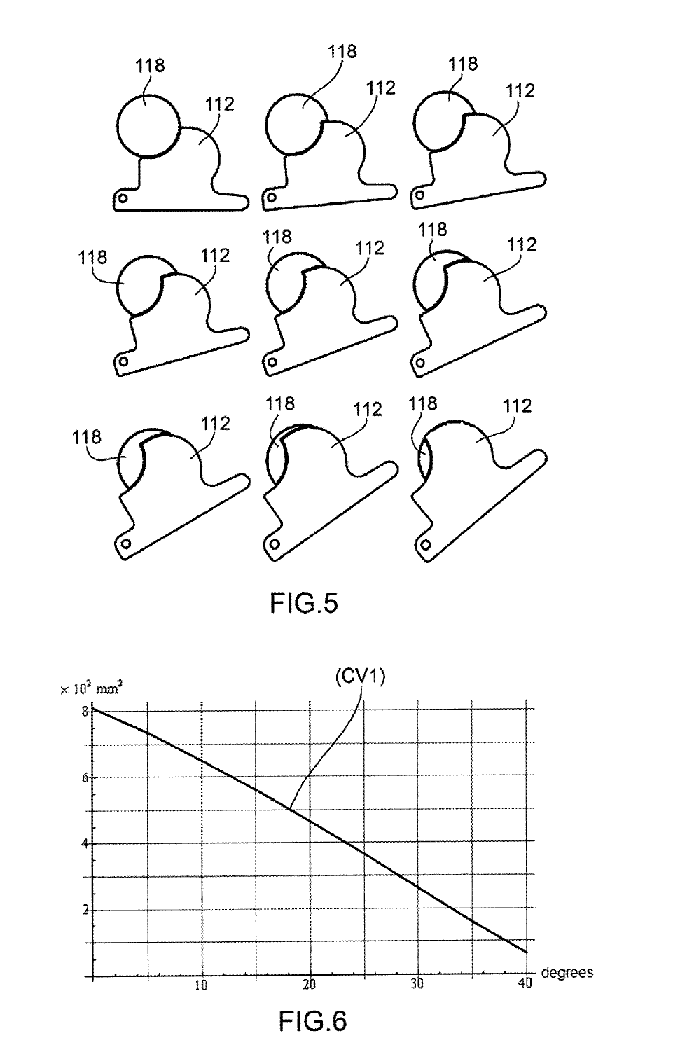

FIG. 6 illustrates a curve (CV1) which shows the variation of the air-passage section 118 according to the rotation angle of the ring nut 103.

It is worth noting that the curve pattern (CV1) in FIG. 6 is linear, by good approximation. In the case of the considered combustion process, the variation linearity of the area of the air-passage section 118 is a geometric effect specifically studied during the step of designing to obtain the physical effect explained below.

However, the different combustion processes dependending on different design geometries or different constructional and/or operational burner modes, may require a non-linear variation law, obtainable by means of appropriate design solutions for the shape of the shaped plate 113 and for the arc-of-circle-shaped groove 114.

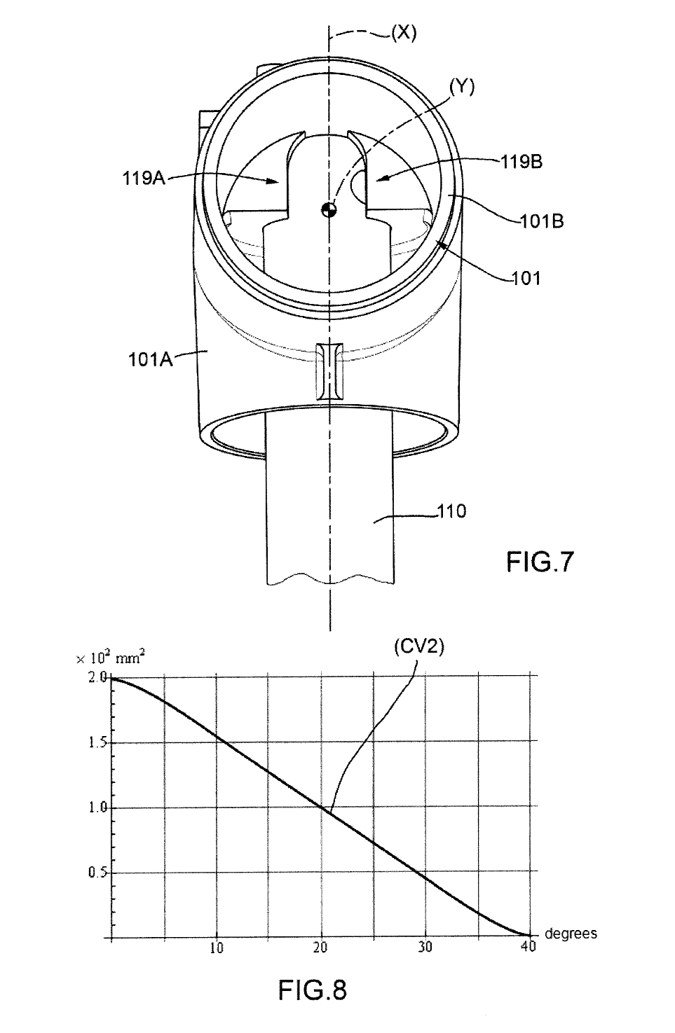

FIG. 7 is a bottom view of sleeve 101. This figure shows (from the bottom) how the premixing pipe 110 is accommodated within the sleeve 101 itself. The premixing pipe 110 is held in position by two side containment elements 119A, 119B arranged on opposite sides with respect to the premixing pipe 110 itself.

In addition to the aforesaid task of supporting the premixing pipe 110, the side containment element 119B also has to partialize the section of eyelet 111 (FIG. 3) on the cylindrical surface of the premixing pipe 110, in order to allow a fraction of the gas from the bottom through the portion 101B of sleeve 101 to enter into the premixing pipe 110 for a first mixing with the air introduced through the air-passage section 118 left open by the shutter 112.

FIG. 8 shows a curve (CV2) which illustrates the section variation of eyelet 111 according to the rotation angle of the ring nut 103.

There is more. Shutter 112 and premixing pipe 110 have synchronized rotations by means of the tab 107 of ring nut 103 which, as mentioned, is engaged in use with recess 109.

The synchronization between the rotations of shutter 112 and those of premixing pipe 110 is responsible for such an eyelet 111 of the premixing pipe 110 being all open (point (0.2) of the curve (CV2) in FIG. 8), in the maximum opening position of shutter 112 (first drawing in FIG. 5, corresponding to point (0.8) of the curve (CV1) in FIG. 6), while eyelet 111 is completely closed (see point (40.0) in (CV2) in FIG. 8) in the minimum opening position of shutter 112.

Device 100, comprising shutter 112, premixing pipe 110, ring nut 103 and sleeve 101, serves the function of finely adjusting the air-gas mixing of the comburent and combustible fractions introduced into the premixing pipe 110 by means of the synchronized operations of opening/closing the air-passage section 118 and the eyelet 111.

In general, the air/gas pre-combustion mixing determines an amount of nitrogen oxides (NOx), measurable in ppm (parts per million, i.e. the ratio of the volume of polluting products with the total volume of the combustion products), as secondary combustion product.

In technical literature about this topic, the NOx produced in a combustion kept stable by means of a gas burner, are commonly made quantitatively dependent on a numeric quantity called “Equivalence Ratio” and indicated by letter Φ.

Such an “Equivalence Ratio” Φ is thus defined:

Φ=R/q (F1)

where “R” is the “Stoichiometric Ratio”, i.e. the air mass needed to completely burn a combustible mole divided by the mass of combustible mole, while “q” is the so-called “stoichiometry” of the combustion process.

“Stoichiometry” “q” is an increasing empiric function of the ratio of the air mass actually used in the process to completely burn a combustible mole with the mass of combustible mole itself.

The value of the “Stoichiometric Ratio” “R” only depends on the chemical features of the combustible, while the value of “stoichiometry” “q” depends on the design modes of the burner and on the modes accordingly used in the associated combustion process. The latter depend on the local design features, whereby the value of “stoichiometry” “q” varies depending on the geometries and on the fluid-dynamics of the burner. It is usually determined experimentally. In the common combustion processes in a gas burner, normally Φ<1, i.e. the process occurs “in air excess”, using the common technical terminology.

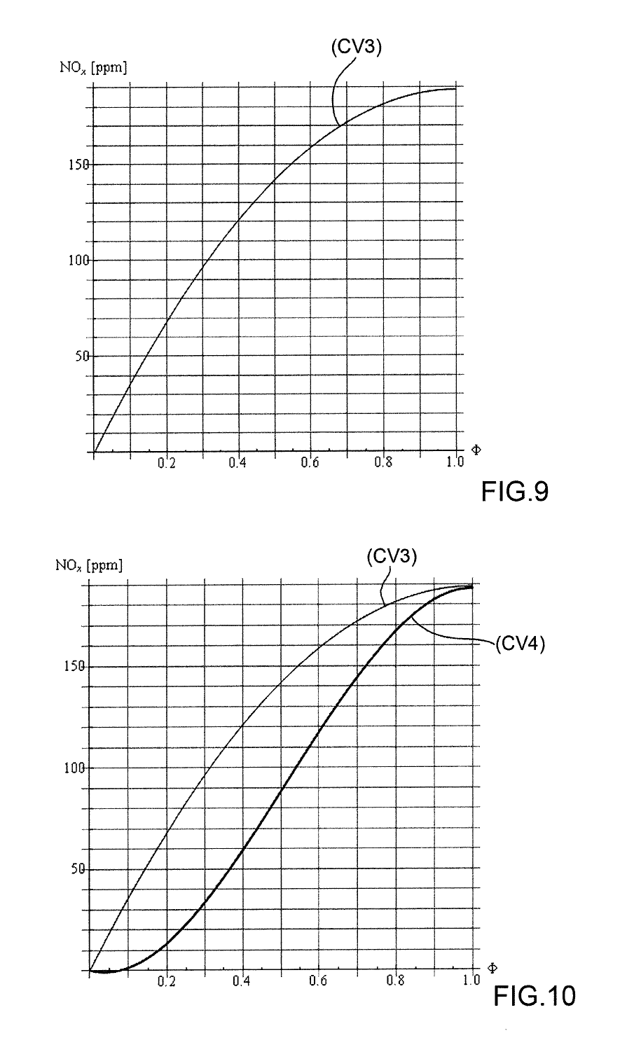

The curve (CV3) shown in FIG. 9 may be constructed by using a theoretical model tried and tested in the combustion field, and experimental data detected on a gas burner on which the above-described device 100 was not fitted.

The curve (CV3) in FIG. 9 shows the NOx production in relation to the “Equivalence Ratio” Φ.

As known, for each type of combustible, the value of “Stoichiometric Ratio” “R” is fixed, because it depends only on the chemical features of the combustible. For example, the “Stoichiometric Ratio” “R” of methane gas (CH4) is 17.1.

The usual value of “Equivalence Ratio” Φ during the operation of the burner is about 0.2, where a production of NOx of about 70 ppm is found.

Furthermore, the “Combustion Efficiency” meant as the thermal efficiency of the system, is about 0.85.

We will now describe what happens if the device 100 object of the invention is fitted on the same gas burner taken into consideration.

Starting from the last configuration shown in FIG. 5 (i.e. with the minimum air-passage section 118 being open) and starting to slowly rotate the ring nut 103 according to a determined angle value from 40° to 0°, a rotation of the pre-mixing pipe 110 according to the same angle value is obtained, due to the feeding caused thereon by the tab 107 coupled to recess 109.

Such a feeding is due to the rotation of shutter 112 which feeds, in turn, the screw 115 screwed into the threaded hole 106 obtained on ear 105.

This allows a further faction of the air flow from the ventilation system to enter into the premixing pipe 110 through the air-passage section 118, and a fraction of gas from the portion 101B of sleeve 101 to enter into the same premixing pipe 110 through the eyelet 111.

By comparing the curves (CV1) and (CV2) (FIGS. 6, 8), the fraction of air flow rate entering into the premixing pipe 110 is higher than the corresponding gas flow rate entering into the premixing pipe 110, as the air-passage section 118 is larger than the free section of eyelet 111.

For example, in the case practically discussed, the flow of comburent air is about four times that of combustible gas, assuming that air and gas maintain their rates unchanged with respect to the outer zone of sleeve 101 and premixing pipe 110, respectively.

According to the desired objectives and by means of alternative constructional contrivances, the ratio of the entering fluid fractions may take a different value, either constant or variable with respect to the rotation angle of ring nut 103.

Therefore, an air-gas mixing is obtained within the premixing pipe 110 at the pre-combustion step.

The amounts of air and gas introduced into the overall system do not change as compared to the situation of not-rotated device 100 (first configuration shown in FIG. 5). The local fluid-dynamics changes instead, i.e. that which may be computed in a confined region of the physical system represented by the burner 10, because at the end 110A of the premixing pipe 110, adjacent to the combustion head 12 (FIG. 1), the ratio of the local air flow rate with the local gas flow rate has a higher value than the corresponding external flows to sleeve 101 and to premixing pipe 110, respectively.

The effect of this localized variation is to alter the value “q” to be used in formula (F1), namely to increase it as there is a considerable increase of the ratio of the air mass with the gas mass in a localized area.

Therefore, since in formula (F1) the value of “R” is invariable because it is only linked to the combustible type, the numeric effect equivalent to the physical effect is a decrease of the value of “Equivalence Ratio” Φ associated with the process, and thus, according to the curve (CV3) shown in FIG. 9, there is a decrease of the amount of NOx generated by the burner.

FIG. 10 shows a curve (CV4) compared with the previous curve (CV3) shown in FIG. 9.

The curve (CV4) shows the pattern of ppm values of NOx according to the “Equivalence Ratio” Φ, as obtained by means of experimentation with the same burner used to obtain the curve (CV3) in FIG. 9 and, now, using the device 100 object of the invention.

Curve (CV4) corresponds to a 40° rotation of ring nut 103, i.e. as much as allowed. In such an operating condition, the combustion efficiency of the system is about 0.84, and thus the decrease of NOx is not accompanied by a significant decrease of thermal efficiency.

It is worth noting now that for a value Φ=0.2, the emitted NOx amount dropped under 15 ppm, with a decrease of about 55 ppm with respect to the process without using device 100.

The rotations of ring nut 103 may be carried out either manually or by means of servomechanisms (not shown), which automatically act on the ring nut 103 itself, according to the values, measurable during the operation of burner 10 by means of specific instrumentation of known type, of the fundamental physical parameters of the combustion process (such as, for example, the percentages of CO, CO2, O2, the temperatures in the boiler 50, or the temperature of the fumes, etc.).

We can thus conclude that the device 100 object of the present invention allows to obtain a considerable decrease of NOx emissions, the combustion system efficiency being equal, by means of fine adjustment of purely mechanical nature of the comburent/combustible premixing in a gas burner.

1. An air-gas premixing device (100) comprising a ring nut (103) capable of rotating around a symmetry axis (X) passing through its geometric center;
the rotation of said ring nut (103) causing:
the rotation of a shutter (112) for closing/opening an air-passage section (118) for a fraction of the air from a ventilation group (11); and
the rotation of a premixing pipe (110) provided with an eyelet (111) for the passage of a combustible gas; so that the air and the combustible gas are mixed in said premixing pipe (110);
said device (100) being characterized in that the coupling between the ring nut (103) and the shutter (112) is carried out by means of a pin element (115), integral with said ring nut (103), sliding in a curvilinear arc-shaped groove (114) obtained on said shutter (112).

2. A device (100) according to claim 1, characterized in that the coupling between the ring nut (103) and the premixing pipe (110) is carried out by means of a tab (107) integral with said ring nut (103), engaged with a recess (109) obtained on said premixing pipe (110).

3. A device (100) according to claim 1, characterized in that said shutter (112) comprises a shaped plate (113) provided with a recess (117) at said air-passage section (118).

4. A device (100) according to claim 3, characterized in that different NOx removal values are obtained according to the shape of said shaped plate (113), and in particular according to the shape and width of said recess (117).

5. A device (100) according to claim 1, characterized in that said premixing pipe (110) is held in position by two side containment elements (119A, 119B) placed on opposite sides with respect to the premixing pipe (110) itself.

6. A device (100) according to claim 5, characterized in that a side containment element (119B) also serves the function of partializing the eyelet section (111).

7. A device (100) according to claim 1, characterized in that it includes at least one servomechanism automatically acting on the ring nut (103) according to the values of the fundamental physical parameters of the combustion process.

8. A gas burner (10) comprising at least an air-gas premixing device (100) according to claim 1.
